(19) United States
(12) Patent Application Publication
(10) Pub. No.: US 2008/0102010 A1
(43) Pub. Date: May 1, 2008

(54) Method and Device for Treating Exhaust Gases of Internal Combustion Engines

(75) Inventors: Rolf Bruck, Bergisch Gladbach (DE); Peter Hirth, Rosrath (DE); Wolfgang Held, Wolfsburg (DE); Eberhard Jacob, Krailling (DE); Ulf Klein, Neunkirchen-Seelscheid (DE)

Correspondence Address: LERNER GREENBERG STEMER LLP, P O BOX 2480, HOLLYWOOD, FL, 33022-2480, US

(73) Assignee: EMITEC GESELLSCHAFT FUR EMISSIONSTECHNOLOGIE MBH, Lohmar (DE)

(21) Appl. No.: 11/949,315

(22) Filed: Dec. 3, 2007

Related U.S. Application Data
(63) Continuation of application No. PCT/EP2006/005261, filed on Jun. 2, 2006.

(30) Foreign Application Priority Data
Jun. 3, 2005 (DE) DE102005026032.2
Jun. 15, 2005 (DE) DE102005027784.5

(51) Int. Cl. B01D 53/56; F01N 9/00

(52) U.S. Cl. 423/213.2; 423/239.1; 60/301

(57) ABSTRACT

A device for treating exhaust gases includes a particle separator, an SCR catalytic converter for selectively reducing nitrogen oxides and an ammonia generator for generating ammonia as a selective reducing agent for reducing nitrogen oxides. The particle separator is provided in a main exhaust line and the ammonia generator is provided in a first secondary line. The first secondary line opens into the main exhaust line at a junction in such a way that an ammonia-containing gas stream generated in the ammonia generator can flow through the SCR catalytic converter. The method and the device advantageously permit the proportion of particles and nitrogen oxides (NOₓ) contained in the exhaust gas of an internal combustion engine to be reduced simultaneously, with the energy consumption for this reduction being small and at the same time the entire device being embodied as a compact unit.

### CROSS-REFERENCE TO RELATED APPLICATIONS

This is a continuing application, under 35 U.S.C. § 120, of copending International Application No. PCT/EP2006/005261, filed Jun. 2, 2006, which designated the United States; this application also claims the priority, under 35 U.S.C. § 119, of German Patent Applications DE 10 2005 026 032.2, filed Jun. 3, 2005 and DE 10 2005 027 784.5, filed Jun. 15, 2005; the prior applications are herewith incorporated by reference in their entirety.

### BACKGROUND OF THE INVENTION

### Field of the Invention

The subject matter of the present invention is a method and a device for treating exhaust gases of internal combustion engines, in particular for reducing the nitrogen oxide content and particle content of those exhaust gases. The invention is preferably applied in motor vehicles.

Internal combustion engines produce exhaust gases which have different compositions depending on the type, volumetric capacity and operating state of the internal combustion engine. In many countries, those exhaust gases have to comply with legal limiting values, which are always gradually being made more stringent, both for the stationary field of applications, for example in power generating plants, and in mobile use, for example in motor vehicles, boats or aircraft. Those limiting values can often only be complied with through the treatment or post-treatment of exhaust gas. Since limiting values have to be complied with for a large number of exhaust gas components, relatively complex devices and methods are also necessary for the post-treatment of exhaust gases. That requires a large number of different exhaust gas cleaning components, the operation of which can respectively have effects on the concentration of another component of the exhaust gas as is the case, for example, for the concentration of nitrogen oxides and particles, in particular in the exhaust gas of diesel engines.

Methods have been proposed for the reduction of nitrogen oxides which are based on the selective catalytic reduction (SCR) of nitrogen oxides. In that case, a selective reducing agent such as, for example, ammonia (NH₃) is used which leads to a selective catalytic reduction of nitrogen oxides at a correspondingly configured catalytic converter. Since direct supply of ammonia is problematic in particular in mobile applications, it has often been proposed to supply ammonia precursors such as, for example, urea, isocyanic acid, cyanuric acid or ammonium carbamate. In particular, supplying urea in an aqueous solution has been developed to the point of introduction into the market. Those systems have the disadvantage that an additional reservoir container for the ammonia precursor is necessary, which is disadvantageous in particular in mobile applications due to the small installation space, in particular in the field of passenger cars, and which additionally requires a surface-covering system with which the ammonia precursor can be filled, since without an ammonia precursor nitrogen oxides are not converted at all, and as a result no further conversion can occur when the reservoir container is empty.

Furthermore, systems have been proposed for generating ammonia on-board. For example, German Published, Non-Prosecuted Patent Application DE 102 58 185 A1, corresponding to U.S. Patent Application Publication No. US 2004/0168905 A1, discloses generating ammonia from atmospheric nitrogen through plasma-supported formation of nitrogen monoxide and subsequent reduction of that nitrogen monoxide to form ammonia with a water-containing gas stream. That system has the disadvantage that only nitrogen oxides and not other components of the exhaust gas are considered.

### BRIEF SUMMARY OF THE INVENTION

It is accordingly an object of the invention to provide a device and a method for reducing concentrations of nitrogen oxides and particles in an exhaust gas of an internal combustion engine, which overcome the hereinafore-mentioned disadvantages of the heretofore-known devices and methods of this general type, which permit simultaneous reduction of both components and which at the same time do not require a further operating material to be carried along.

With the foregoing and other objects in view there is provided, in accordance with the invention, a device for treating or preparing exhaust gases. The device comprises a main exhaust line, a particle separator disposed in the main exhaust line, a first secondary line, an ammonia generator disposed in the first secondary line for generating ammonia as a selective reducing agent for reducing nitrogen oxides and an SCR catalytic converter for selectively reducing nitrogen oxides. The first secondary line opens into the main exhaust line at a junction causing an ammonia-containing gas stream generated in the ammonia generator to flow through the SCR catalytic converter.

In accordance with another feature of the invention, the ammonia-containing gas stream also preferably flows through the particle separator. The provision of the ammonia generator in the first secondary line means, in particular, that the ammonia generator can be provided in a bypass of the exhaust line. On the other hand, it is also possible to connect the first secondary line to the exhaust line in such a way that the ammonia (NH₃) which is formed can be fed into the exhaust line, but the exhaust gas cannot be fed through or to the ammonia generator. Particles are understood in this case to be, in particular, carbon-containing particles or particles made of pure carbon.

The particle separator, the SCR catalytic converter and the ammonia generator can each include at least one honeycomb body. A honeycomb body is understood to be a body with a large wall surface which has cavities through which a fluid such as an exhaust gas can at least flow. A honeycomb body can be fabricated, for example, from ceramic material, for example by extrusion. Furthermore, a honeycomb body can also be constructed from metallic layers. These can include, for example, at least partially structured layers which are wound in a helical shape, if appropriate together with one or more substantially smooth layers. Another exemplary embodiment of a honeycomb body also includes metallic layers which are stacked. One or more stacks are wound in the same direction or in opposite directions. A stack can include at least one at least partially structured layer and, if appropriate, at least one substantially smooth layer. A honeycomb body which includes a non-twisted stack of at least one at least partially structured and, if appropriate, at least one substantially smooth metallic layer is also possible according to the invention.

A metallic layer is understood in particular to be sheet metal foils, fiber nonwovens, sintered porous metallic layers, wire mesh layers or combinations of at least two of these elements. An at least partially structured layer is understood to be a layer which has, at least in certain areas, structures which form cavities after the winding on, stacking or twisting. In particular, these structures can have a wavelike construction. A substantially smooth layer is understood to be a layer which is smooth and, if appropriate, has microstructures. Microstructures are structures which have a structuring amplitude that is significantly smaller than the structuring amplitude of the at least partially structured layer.

The particle separator can, in particular, be open or closed. A closed particle separator is constructed in such a way that the exhaust gas has to pass through at least one wall of the particle separator as the exhaust gas flows through. This can be achieved, for example, by virtue of the fact that the particle separator is formed with a plurality of cells which are separated by porous walls and which are alternately closed off at the gas inlet-end and gas outlet-end face of the honeycomb body so that a first group of cavities is present with end sides which are open at the gas inlet side and end sides which are closed at the gas outlet side, and a second group of cavities is present with end sides which are closed at the gas inlet side and end sides which are open at the gas outlet side.

A particle separator can also include an open particle filter. A particle filter is referred to as open if basically particles can run through it completely, and specifically also particles which are considerably larger than the particles which are to be actually filtered out. As a result, such a filter cannot become blocked during operation just when particles agglomerate. A suitable method for measuring the openness of a particle filter is, for example, testing the diameter to which spherical particles can still trickle through such a filter. In present application cases a filter is open in particular if spheres larger than or equal to 0.1 mm in diameter, preferably spheres with a diameter above 0.2 mm, can still trickle through.

The particle separator can be formed in particular from metal foam and/or ceramic foam. The particle separator can have cavities which are shaped in a regular, irregular or chaotic fashion.

The SCR catalytic converter preferably includes a honeycomb body which is provided with an SCR coating. The latter includes in particular a titanium dioxide (anatase)-supported vanadium/tungsten mixed oxide or metal-exchanged zeolites, in particular of the type X, Y, ZSM-5 or ZSM-11, preferably iron-exchanged zeolites. If an on-board ammonia generator is provided, it is advantageously possible to dispense with a hydrolysis catalytic converter which is usually required to hydrolyse urea.

The device according to the invention provides in particular advantages in terms of connection and operation. It is thus possible for a single device to be used which simultaneously reduces two critical exhaust gas components that are coupled to one another. In particular, the device according to the invention can also be controlled in such a way that both the proportion of nitrogen oxides and that of particles are reduced in the same way. The device according to the invention can be considered to be what is referred to as a black box in which the user and also the system planner for exhaust systems do not have to worry about the detailed method of functioning of the components that are installed in this box but rather with which only connection to the exhaust system and to a power supply has to be carried out.

The junction is advantageously embodied in such a way that the ammonia-containing gas stream also flows through the particle separator. Ammonia is advantageous in the regeneration of the particle separator.

The particle separator preferably includes alternately closed cells which are separated from one another through the use of walls through which a fluid can at least partially flow.

The particle separator is preferably constructed in such a way that an exhaust gas can flow through the wall. Depending on the embodiment, the exhaust gas can partially flow through the wall, in particular in the case of an open particle separator, or can flow entirely through the wall. In particular, in such a case a closed filter with alternately closed cells can be present. The walls can preferably have a ceramic and/or metallic construction.

The particle separator preferably includes an at least partially metallic carrier. A partially metallic carrier can, for example, be a metallic honeycomb body embodied as described above. Another example is a ceramic carrier in which metallic structures, for example as electrodes for electrostatic agglomeration and/or separation of particles, are provided.

The at least partially metallic carrier preferably includes at least one metallic layer. In this context, the SCR catalytic converter, the ammonia generator and/or the particle separator preferably include a honeycomb body having at least one metallic layer. Furthermore, additional carrier bodies including at least one metallic layer may be provided.

The particle separator preferably includes a ceramic filter element which has metallic portions.

In particular, the ceramic filter element can be constructed in a layered fashion, especially through the use of corresponding rapid manufacturing techniques. A layered structure is understood in this case to mean in particular that first a first layer of the body is constructed from one or more raw materials, these are then strengthened at least in partial regions and then a further layer made of one or more raw materials is applied to this strengthened layer. This layer is then also strengthened at least in partial regions and then the procedure described above is adopted further until the filter element is finished.

A raw material can form the later ceramic wall, while a further raw material can form the later metallic portion. The strengthening can be based on a brief increase in temperature which is achieved, for example, by irradiation with laser light. Spatially selective and/or inhomogeneous heating and/or use of a raw material which is applied in a spatially selective and/or inhomogeneous fashion makes it possible to generate cavities which are separated by walls in such a way that they can, for example, also have micro-structured walls. Furthermore, by using a plurality of raw materials it is possible to construct walls with areas with different properties which have, for example, different porosity values or else electrical conductivity values in different areas. In this way it is also possible for the distribution of flow in the filter element to be predefined after it is finished through the formation of the metallic portions, and thus, in the case of an electrostatic agglomeration and/or separation in the filter element, to be able to predefine what degree of separation occurs in which areas. In particular, selective laser sintering, three dimensional printing and fused deposition modelling techniques can advantageously be used for the construction.

It is preferred to form a particle separator which has cavities through which a fluid can at least flow and which are at least partially separated from one another by walls.

A cavity through which a fluid can flow is understood, for example, to be a cell which is closed off at the termination side. In particular, fluid can also flow through the cavities. It is also possible preferably to form cavities which have larger dimensions than the cells. Such cavities can preferably serve to mix the exhaust gases better.

The walls preferably have at least one of the following properties:
a) the walls have an at least partial coating; or
b) the walls include at least one catalytically active component.

The particle separator or the filter element can have a coating according to item 8.1), which also applies to all of the other honeycomb bodies disclosed herein. The coating can, in particular, be ceramic and/or include a wash coat and/or zeolites. According to item 8.2), the walls of the particle separator can include catalytically active components, which applies also to the walls of all of the other honeycomb bodies disclosed herein. The components can be introduced into a coating embodied according to item 8.1) or else directly into and/or onto the wall. The latter is preferred if these walls include ceramic material. The catalytically active component can preferably include noble metals, for example in the form of noble metal complexes. The plurality of noble metals can preferably be included in the catalytically active component.

The particle separator can, for example, include an oxidation-promoting catalytically active component, preferably in the region of one of the end sides, preferably in the end region on the flow inlet side. The end sides can, in particular, catalyze the oxidation of nitrogen monoxide to form nitrogen dioxide. The particle separator which operates according to the CRT (Continuous Regeneration Trap) principle in the case of continuous regeneration is required. Furthermore, a catalytically active component, which catalyzes the CRT regeneration reaction, can be provided on the particle separator. Such a coating can preferably be provided in the entire particle separator. An oxidation-promoting coating can, for example, also catalyze oxidation of hydrocarbons which leads to heating of the particle separator. The hydrocarbons can, for example, be introduced into the particle separator by virtue of the fact that the internal combustion engine is, for example, operated for a short time with a cylinder of the internal combustion engine in a cycle with an increased proportion of fuel, that is to say in rich mode. As a result, hydrocarbons can reach the particle separator and oxidize there.

In accordance with a further feature of the invention, the particle separator has a regeneration facility or ability for regenerating the particle separator. In this context, it is particularly preferred that the regeneration facility be generated by at least one of the following measures:
a) making available nitrogen dioxide upstream of at least part of the particle separator;
b) increasing the temperature of at least part of the particle separator above a limiting temperature;
c) making available an oxidizing agent upstream of at least part of the particle separator; or
d) regeneration through the use of an electrical discharge.

In the application of one of the methods 10.1) to 10.4) to a part of the particle separator, it is understood that the corresponding measure can, if appropriate, be carried out on part of the particle separator itself (in cases 10.1) and 10.3)) or in part of the particle separator (10.2). A regeneration facility is understood to mean the suitability of the particle separator for regenerating the particles which have become embedded and/or deposited, that is to say the removal of the particles from inside and/or outside the particle separator. This regeneration facility can, in particular, be of a thermal and/or chemical nature. If the particle separator has a thermal regeneration facility, it is possible to provide a device which can cause the particle separator to be heated above a temperature at which the hydrocarbon of the particles oxidizes, preferably also with a residual oxygen content in the exhaust gas. The particle separator can include catalytically active materials which catalyze such oxidation. Thermal regeneration can be achieved by increasing the exhaust temperature and/or through the use of additional heating devices.

If the particle separator has a chemical regeneration facility, it is possible to decompose the particles through a chemical reaction. This can be achieved, for example, through the use of a reaction of the carbon with nitrogen dioxide to form nitrogen monoxide and carbon dioxide. A further possibility for a regeneration facility is a CRT method in which devices are provided which as continuously as possible ensure a sufficiently large nitrogen dioxide concentration in the exhaust gas in the particle separator in order to continuously convert the carbon particles. A regeneration facility which is based on electrical discharge is based, for example, on surface creeping discharge.

In accordance with an added feature of the invention, the particle separator includes devices for generating an electrical field in the particle separator through the use of which at least one of the following functions is met:
a) agglomeration of particles; or
b) separation of particles.

The agglomeration of particles is understood in this case to mean in particular the accumulation of a plurality of small particles into relatively large particles. The separation of particles is understood to mean in particular the depositing of particles on the filter.

Fine dust, that is to say for example particles with a diameter of 10 micrometers and less, is an undesired exhaust gas component due to the ability of these particles to become absorbed into the tissue of human lungs. The greater the average diameter of the particles, the smaller the probability of these particles being absorbed into the tissue of the lungs. It is therefore advantageous not only to aim at a separation of particles which can, for example, nevertheless lead to (later) release of small particles due to mechanical effects on the particle separator, but also to aim at agglomeration of the particles into relatively large particles in order to reduce the proportion of fine dust in the exhaust gas and as far as possible bring about average diameters of the particles such that they can predominantly no longer be absorbed into the tissue of the lungs.

Such agglomeration can also be achieved by applying an electrical field. The electrical field can be generated, for example, by virtue of the fact that the particle separator has a ground pole and a pole at a positive potential so that a corresponding electrical field is provided in particular transversely to with respect to a longitudinal axis of a cell or the direction of through-flow of the particle separator. A plurality of poles which build up such a field can also preferably be provided parallel to one another so that the particle separator includes a plurality of electrical fields for agglomerating and separating particles. The fields can in particular be operated through the use of a direct voltage but operation with an alternating voltage, in particular a low-frequency alternating voltage with a frequency of 10 Hz or less is also possible according to the invention.

Soot particles are drawn to one of the electrical poles and deposited there by polarization thereof. The poles can in particular be combined with the walls of the particle separator, in particular constructed as part thereof or can form them themselves. In this context, the particle separator is preferably formed from metal foam, with the particle separator preferably having at least two components which in particular have a correspondingly matching construction. The particle separator is particularly preferably formed from a metal foam which forms a plurality of cavities through which exhaust gas flows.

In accordance with an additional feature of the invention, the particle separator preferably includes devices for generating a second electrical field in the particle separator through the use of which a surface creeping discharge is generated for the purpose of regeneration of the particle separator.

The details of the particle separator which are disclosed within the scope of this application, can also be implemented in isolation without the other components of the device.

In accordance with yet another feature of the invention, the ammonia generator includes a plasma generator.

The plasma generator can be provided in this case in particular as described in German Published, Non-Prosecuted Patent Application DE 102 58 185 A1, corresponding to U.S. Patent Application Publication No. US 2004/0168905 A1, the content of the disclosure of which, in particular with respect to the operating parameters of the plasma generator, the formation of the electrodes and the addition of process gas, is incorporated into the content of the disclosure of this application. The plasma generator is preferably operated in such a way that the process gas is briefly heated to temperatures above 2500 K. The plasma generator is operated with a nitrogen-containing and oxygen-containing gas as a process gas, wherein the operating parameters of the plasma generator are selected in such a way that the reaction equilibrium of the reactions occurring in the plasma is displaced so that preferably nitrogen monoxide is generated. This nitrogen monoxide can then be reduced to form ammonia through the use of a correspondingly constructed reducing catalytic converter, which is mounted in particular on a honeycomb body, with the addition, for example, of hydrogen and/or hydrocarbons as a reducing agent. In particular, air, exhaust gas or exhaust gas which is enriched with air can be used as the process gas.

In accordance with yet a further feature of the invention, it is preferred in this case to provide an ammonia generator which includes at least one storage element for temporarily storing at least one of the following components:
a) ammonia; or
b) an ammonia precursor.

An ammonia precursor is understood to be a substance which releases ammonia, for example through thermolysis, pyrolysis and/or hydrolysis, or which can react with a further educt to form ammonia. It is preferred in this case that the component 15.2) include nitrogen monoxide since a relatively high yield of ammonia with a relatively low additional consumption of fuel can be achieved to reduce the nitrogen monoxide to ammonia in this case, in particular in conjunction with an ammonia generator which includes a plasma generator. The stored components 15.1) and/or 15.2) can in particular also be used as buffers for very large NOₓ concentrations which occur in the exhaust gas and for which a relatively large quantity of ammonia is required. Furthermore, the storage element can advantageously be used for the intermittent storage and emission of nitrogen monoxide, as presented above. Ammonia precursors are understood to be both nitrogen monoxide and, for example, urea, isocyanic acid, cyanuric acid or ammonium carbamate.

It is also preferred in this case that the storage element temporarily stores the at least one component by sorption, in particular chemisorption and/or physisorption.

Physisorption is understood in this case to be in particular storage on the basis of physical interactions, while chemisorption is understood to be adsorption which is based on a chemical bond. Physisorption occurs in particular at low temperatures below a first limiting temperature, while desorption of the ammonia precursor occurs above this first limiting temperature. Chemisorption occurs to an appreciable degree above a second limiting temperature since a correspondingly displaced reaction equilibrium requires a certain temperature. Appropriate selection of the storage element, for example a correspondingly configured coating of the storage element, allows the first and second limiting temperatures to be selected in such a way that adsorption of nitrogen monoxide is made possible over a wide temperature range.

A corresponding coating of a honeycomb body can be configured, for example, in such a way that a region of the coating which is further removed from a surface through which exhaust gas flows is more suitable for physisorption while a region which is located closer to a surface of the coating through which exhaust gas is flowing is more suitable for chemisorption.

It is thus possible, for example, to provide an ammonia generator which has at least two storage elements, one of which is filled with nitrogen monoxide, while another storage element at least partially emits the nitrogen monoxide that is stored in it, so that it can be reduced to form ammonia. In particular, the emission of the nitrogen monoxide can occur in this case into a gas stream which contains hydrogen and as little oxygen as possible. This reduces the required proportion of hydrogen since hydrogen would generally firstly react with oxygen. If the process gas of the plasma generator includes at least air, the proportion of oxygen of the process gas as it leaves the plasma generator is still relatively high, for example in the range from 18% to 19%. If a low-oxygen, hydrogen-containing gas is used in which the nitrogen monoxide is prepared, the amount of hydrogen required is significantly smaller than if the process gas were to be mixed directly with a hydrogen-containing gas.

The hydrogen-containing gas can, in particular, be a cracking gas or synthetic gas which is generated through partial oxidation of hydrocarbon. In particular, the fuel which is used to operate the internal combustion engine can serve as an educt for the cracking gas or synthetic gas. Since the required proportion of hydrogen is reduced, the additional consumption of fuel is also reduced compared to conventional systems. The plasma generator can be operated intermittently with two gas lines which each include a storage element for temporarily storing nitrogen monoxide and, if appropriate, a reducing unit for reducing nitrogen monoxide to form ammonia. The reducing unit for reducing nitrogen monoxide to form ammonia can, if appropriate, also be charged jointly by both gas lines. Furthermore, it is possible to construct the storage element and reducing unit in a single component, for example by forming a honeycomb body with a corresponding storage reducing coating.

Cracking gas and/or synthetic gas can be generated in a correspondingly constructed reformer or reactor, preferably in a second secondary line. It is preferred in this case to generate the cracking gas and/or synthetic gas through partial oxidation of hydrocarbons. The second secondary line is in particular constructed in such a way that it opens into the first secondary line upstream of the at least one storage element so that the cracking gas and/or synthetic gas can flow through the at least one storage element.

Furthermore, the ammonia generator can alternatively or cumulatively include devices which enrich nitrogen monoxide in a gas stream, for example in that a gas stream which contains nitrogen oxides (NOₓ) is divided into a first gas stream in which the relative proportion of NO in NOₓ is increased and a second gas stream in which the relative proportion of NO₂ in NOₓ is increased. This is possible, for example, through the use of corresponding diaphragms.

A further possibility is a storage element which can selectively store only nitrogen monoxide, but not nitrogen dioxide. This can be achieved through the use of correspondingly constructed molecular sieves, in particular zeolites. Exhaust gas can then flow through such a storage element until a certain quantity of nitrogen monoxide is stored. The nitrogen monoxide which is temporarily stored in this storage element can then be released, for example, by changing a physical and/or chemical process variable, and can be emitted into a hydrogen-containing gas stream, after which a reduction to form ammonia is also catalyzed through the use of a corresponding catalyst.

The possibilities described in this case for directly enriching or storing nitrogen monoxide from the exhaust gas can preferably also be implemented in the main exhaust gas flow and in particular also without a particle filter or an SCR catalytic converter being provided.

The ammonia generator preferably includes devices for feeding a reducing agent for reducing nitrogen monoxide to form ammonia. The latter can preferably be connected to a reservoir container for the reducing agent and/or a reactor and/or reformer which forms the reducing agent.

It is also preferred for the reducing agent to include at least one of the following substances:
a) hydrocarbons; or
b) hydrogen.

It is preferred to provide first reduction devices which are constructed in such a way that nitrogen oxides, preferably nitrogen monoxide, can be reduced on or in them with the reducing agent 19.1) and/or 19.2). In particular, nitrogen oxides can be reacted in bound form, for example with chemisorbed nitrogen oxides which are present in the form of nitrite or nitrate groups.

In particular, devices are provided for making available and/or generating the reducing agent. These include in particular a reformer and/or a reactor for the partial oxidation of hydrocarbons. The devices for supplying the reducing agent preferably include a mixer which is suitable for mixing the reducing agent with another gas. This may be an active and/or a passive mixer.

In accordance with yet an added feature of the invention, at least one of the following gases flows through the first secondary line:
a) exhaust gas;
b) a gas including at least oxygen and nitrogen; or
c) air.

In this context, according to the invention any desired mixture ratios of the gases 24.1), 24.2) and 24.3) may occur. In particular, the pure exhaust gas can flow through the first secondary line, preferably if the exhaust gas has a high proportion of oxygen, for example if the internal combustion engine is a diesel engine. Furthermore, pure air can flow through the first secondary line. In particular if a plasma generator is included in the ammonia generator, it may be advantageous to configure the first secondary line in such a way that a hydrogen-containing gas can flow through the secondary line in addition to the gases 24.1), 24.2) and/or 24.3) in order to bring about a reduction of nitrogen monoxide to form ammonia in this way. The first secondary line is preferably configured in such a way that the ratios of gases 24.1), 24.2) and/or 24.3) with respect to one another can be adjusted and/or changed.

In accordance with yet an additional feature of the invention, the particle separator includes devices for generating an electrical field in the particle separator, and the ammonia generator includes a plasma generator, in which case at least one control device is provided for generating and performing closed-loop control of the electrical field of the particle separator and for actuating the plasma generator.

In particular, the use of a single control device is advantageous both for the particle separator and for the plasma generator since the operating conditions of the two components can be adjusted to one another in an optimum way. In particular, a common control device can carry out an operating method in which the proportion of particles, the distribution of particle sizes and/or the nitrogen oxide content can be reduced or changed to the same degree. Furthermore, it is possible in this way to carry out a method in which, in addition to an adjustable or selectable reduction or change in the above-specified parameters, the smallest possible additional consumption of energy and/or fuel is achieved at the same time. For this purpose, the control device can also be connected to corresponding sensors, for example temperature sensors, lambda probes, gas partial pressure sensors, etc.

The devices for generating an electrical field include in particular electrodes in the particle separator and a voltage source which can be connected electrically to the electrodes in the particle separator. It is preferred to provide a single control device through the use of which both the devices for generating an electrical field in the particle separator and the plasma generator are controlled and, if appropriate, supplied with electrical energy. In particular, in the case of a cold start it is advantageously possible firstly to supply the devices for generating an electrical field in the particle separator with electrical energy, after which the plasma generator is also supplied with electrical energy after a predefinable time period. This has the advantage that the particles are basically agglomerated and/or deposited, while the nitrogen oxides are not converted until the SCR catalytic converter has reached its minimum operating temperature (“light-off” temperature). However, the SCR catalytic converter does not reach this operating temperature until after a certain time.

The ammonia generator which is described in this application and the first secondary line can also advantageously be implemented even in isolation, that is to say without the other components of the device according to the invention.

In accordance with still another feature of the invention, an oxidizing catalytic converter is provided at least at one of the following locations:
a) upstream of the particle separator;
b) downstream of the ammonia generator and upstream of the SCR catalytic converter; or
c) downstream of the SCR catalytic converter.

At the location 26.1), the oxidizing catalytic converter can in particular catalyze the oxidation of nitrogen monoxide into nitrogen dioxide and thus provide a regeneration facility for the particle separator. At the location 26.3), the oxidizing catalytic converter can serve as a barrier catalytic converter which, for example, effectively prevents ammonia and/or hydrocarbons from breaking through. At the location 26.2), the oxidizing catalytic converter can advantageously serve to consume oxygen which the gas leaving the particle separator may contain. The coatings on the oxidizing catalytic converter, in particular in view of the type and concentration of the catalytically active substances used, can vary at the oxidizing catalytic converters at the locations 26.1), 26.2) and 26.3) and can be adapted to the reaction which is to be respectively catalyzed.

In accordance with still a further feature of the invention, the device includes a first flow region and at least one second flow region, which have substantially parallel flows to one another. The first flow region is at least part of the main exhaust line, and the first flow region and the second flow region are constructed in such a way that heat can be transferred from the first flow region into the at least one second flow region.

The flow regions are preferably coaxial and/or concentric. Furthermore, in accordance with still an added feature of the invention, it is preferred that at least one of the following components be provided in a second flow region:
a) at least one plasma generator,
b) at least one reformer; or
c) at least one reactor.

A plasma generator is preferably provided in a first second flow region, and a reformer or reactor is preferably provided in a second second flow region. The reformer or reactor generate, in particular, hydrogen from hydrocarbons by partial oxidation. Furthermore, a development in which the first and the at least one second flow region are separated from one another through the use of at least one dividing wall is preferred.

In particular, the first flow region lies on a first side of the dividing wall, while the second flow region is provided on a second side of the dividing wall. The dividing wall can be constructed with one or more layers. In particular, it is preferred to construct both flow regions through the use of a planar, materially joined connection between the two customary pipes, in which case the pipes can also be deformed, if appropriate. In addition to a coaxial embodiment of the first and second flow regions, a concentric configuration of these regions is also possible according to the invention.

The device according to the invention permits exhaust gas to be conducted in a first partial flow in the first flow region, and in a second exhaust gas partial flow in a second flow region. Since the components 31.1), 31.2) and/or 31.3) are provided only in the first flow region, it is therefore possible, for example, to ensure without relatively large structural outlay that only one exhaust gas flow or partial gas flow in a flow region is subjected to a treatment with plasma, or partial oxidation of hydrocarbons occurs only in one exhaust gas flow or partial gas flow. It is thus possible, in particular, for a plasma generator to be integrated in a very compact way into the exhaust system of motor vehicles. In particular, the plasma generator is constructed in such a way that exhaust gas in the plasma generator is heated by the gas discharge to temperatures above 2000 Kelvin, preferably above 2800 Kelvin. During operation, molecular nitrogen, which is present both in the exhaust gas and in the air, which can be added if appropriate, and oxygen, are electronically excited, dissociated and ionized through the use of non-thermal, plasma-induced impact processes with highly energetic electrons. Nitrogen oxides are preferably formed through reactions of the electronically excited molecules, radicals and ions with the exhaust gas which is heated by the plasma. Nitrogen monoxide (NO) is preferably formed due to the high prevailing temperature since the reaction equilibrium at these temperatures correspondingly favors the formation of nitrogen monoxide to that of nitrogen dioxide. The reaction times therefor are in the region of less than 10 milliseconds.

It is thus possible for the concentration of nitrogen monoxide to be increased by the plasma generator during operation. This nitrogen monoxide can also preferably be reduced to form ammonia. The plasma generator can be constructed, for example, as described in German Published, Non-Prosecuted Patent Application DE 102 58 185 A1, corresponding to U.S. Patent Application Publication No. US 2004/0168905 A1, the content of which with respect to the construction and the operation of the plasma generator is also completely incorporated into the content of the disclosure of this application.

The device has suitable ports in the region of the plasma generator, with which the plasma generator can be connected to a corresponding power supply and a corresponding controller. Corresponding insulations and the like can be provided according to the invention.

If the plasma generator is operated in such a way that the exhaust gas is briefly heated locally by the gas discharge to extremely high temperatures such as, for example, 2800 Kelvin and more, given the presence of molecular nitrogen (N₂) there is, on one hand, a reaction with oxygen radicals formed by the plasma, in which case nitrogen monoxide and nitrogen are produced, and on the other hand there is a reaction of such a nitrogen atom with molecular oxygen (O₂) to form nitrogen monoxide and an oxygen radical. Further reactions are of rather subordinate importance at relatively high temperatures so that a high yield of nitrogen monoxide can be achieved by using and correspondingly operating the plasma generator.

In accordance with still an added feature of the invention, the at least one second flow region is preferably provided at least at one of the following locations:
a) upstream of a storage element;
b) upstream of a reformer or reactor; or
c) upstream of a plasma generator.

It is thus advantageously possible for heat to be transferred into the respective process gas of the storage element, of the reformer or reactor and/or of the plasma generator so that the energy for operating these components, and thus the entire system, can be reduced. In particular, it is possible in this way for the heat of the exhaust gas which can flow through the first flow region to be used to heat the storage element, the reformer or the reactor and/or the plasma generator. In particular, placement at the location 32.1) is advantageous if sorption occurs at the storage element.

Gas supply devices are preferably provided upstream of the plasma generator in an axially preferred flow direction, in particular in order to supply oxygen and/or a gas including nitrogen.

The gas supply devices can be provided in this case both in the first flow region and in a part of the exhaust gas treatment unit in which the flow regions are not yet separated from one another. Such a region can, for example, be provided upstream by virtue of the fact that the dividing wall is not yet provided there.

For example, ambient air can be supplied as the gas which includes oxygen. This also has the advantage that molecular nitrogen is supplied to the system, and that molecular nitrogen can serve in the same way to form nitrogen monoxide. It is basically possible in this case to supply air under pressure, for example through the use of a compressor.

A common third flow region is preferably provided at least downstream of the first and the second flow regions in an axial, preferred flow direction. The two gas flows which are formed by the dividing wall can flow together again in the flow region after the respective flow regions have been flowed through, and can in particular be mixed in the flow region. While the plasma generator is operating in order to generate nitrogen monoxide in the second flow region, an overall exhaust gas flow which is enriched with nitrogen monoxide is formed in the respective flow region, with the overall exhaust gas flow including both partial exhaust gas flows which flow through the two flow regions. It is also possible to ensure that before the two gas flows are combined, the nitrogen monoxide is reduced to form ammonia by virtue of the fact that, for example, an appropriate catalyst, for example on a catalyst carrier body, is introduced into the first flow region downstream of the plasma generator.

A first honeycomb structure with a first reducing catalyst coating is preferably provided downstream of the plasma generator in an axial preferred direction of flow, in order to reduce oxygen.

This first honeycomb structure can serve in particular to remove the residual oxygen from the exhaust gas flow. This residual oxygen content can be high in particular if air is supplied through the gas supply devices. In particular, a ceramic coating material such as in particular wash coat into which noble metal-containing components containing, for example, platinum and/or palladium, is introduced, is provided as the first reducing catalyst coating.

In one axial preferred direction of flow downstream of the plasma generator, a second honeycomb structure is preferably provided with a second reducing catalyst coating in order to reduce nitrogen oxide to form ammonia. The second reducing catalyst coating includes in particular platinum and/or palladium as active components. In particular, in this coating, only a small amount of rhodium is present, preferably substantially no rhodium.

The two flow regions therefore permit a compact on-board ammonia generator to be made available which can also be used in particular in mobile applications in the exhaust system of internal combustion engines. The ammonia which can be generated in this way can serve downstream as a reducing agent in a selective catalytic reducing process (SCR—Selective Catalytic Reduction) of nitrogen oxides. In particular, in the case of mobile applications it is therefore possible to dispense with the use of tanks for reducing agents such as, for example, ammonia precursors (for example urea, ammonium carbamate, isocyanic acid, cyanuric acid etc.) in solution or as a solid.

As a result of a corresponding embodiment of the second reducing catalyst coating of the second honeycomb structure, it is also possible to catalyze other reactions through the use of which other reducing agents such as, for example, isocyanic acid or cyanuric acid are generated instead of ammonia. Such reducing agents and corresponding second reducing catalyst coatings are also possible according to the invention. The second reducing catalyst coating includes, in particular, noble metals such as, for example, platinum, as catalysts. The second reducing catalyst coating includes, in particular, titanium dioxide (anatase)-supported vanadium/tungsten mixed oxide or metal-exchanged zeolites such as in particular zeolites of the type X, Y, ZSM-5 or ZSM-11.

Reducing supply devices for supplying a reducing agent are preferably provided in the direction of flow between the plasma generator and the second honeycomb structure. If a first honeycomb structure is also provided for reducing in particular the oxygen which is still present, the reducing supply devices are preferably provided between the first and second honeycomb structures.

In particular, hydrocarbons have proven useful as reducing agents for reducing nitrogen monoxide to form ammonia. The latter can easily be acquired from the fuel of the internal combustion engine. It is thus possible, for example, to inject fuel, in particular diesel fuel, from the internal combustion engine into the exhaust gas flow directly upstream of the second honeycomb structure using the reducing supply devices. In particular, the reducing supply devices are constructed as a nozzle. The reducing supply devices are in particular constructed in such a way that the most uniform concentration possible of reducing agent over the flow cross section is achieved. In particular, it has proven useful to spray in the reducing agent in the form of small droplets.

A mixer, in particular a mixer structure, is preferably provided in the common flow region.

A mixer structure can be composed, for example, of a honeycomb structure which has break-throughs between the individual cells, through which break-throughs the exhaust gas can flow at least partially substantially transversely with respect to the direction of flow. As a result, the exhaust gas flow is mixed. It is particularly preferred in this case to form guiding structures in the cell wall which direct the exhaust gas flow to the openings that are located between the cells.

A third honeycomb structure with an SCR catalyst coating is preferably provided downstream of the second honeycomb structure in the direction of flow.

This SCR catalyst coating is a coating which contains a catalyst that catalyzes the selective catalytic reduction of nitrogen oxides. The SCR catalyst coating includes, in particular, titanium dioxide (anatase)-supported vanadium/tungsten mixed oxide or metal-exchanged zeolites such as, in particular, zeolites of the type X, Y, ZSM-5 or ZSM-11.

During operation, selective catalytic reduction of the nitrogen oxides to form a molecular nitrogen can occur due to the proportion of ammonia which is formed in the second honeycomb structure. As a result, the nitrogen oxide emissions of the internal combustion engine are effectively lowered.

In this context it is particularly advantageous if devices for temporarily storing a reducing agent are provided between the second honeycomb structure and the third honeycomb structure.

In particular, these are devices for temporarily storing the reducing agent which is formed in the previous process step. In particular, these are devices for temporarily storing ammonia. However, other reducing agents can also be correspondingly stored, such as for example isocyanic acid or cyanuric acid.

Providing devices for temporary storage permits a certain amount of reducing agent to be stored, and then be used if a concentration of nitrogen oxides which is rising very quickly and very strongly is to be reduced. The storage of a certain quantity of reducing agent in the devices for temporary storage is advantageous in this case for overcoming the possible inertia of the system for generating the reducing agent. In particular, these devices can be coated honeycomb structures which are coated in particular with certain zeolites such as, for example, zeolites of the types A, X, Y or ZSM-5.

It is particularly advantageous in this case to provide a control loop with which on one hand the concentration of nitrogen oxides in the exhaust gas is determined directly or indirectly and which also senses the quantity of stored reducing agent in the devices for temporary storage. In this context, in particular the generation of nitrogen monoxide in the plasma generator is controlled, for example by switching the plasma generator on and off, changing the strength and/or frequency of the flow or changing the composition of the gas, for example by feeding in or changing the quantity of an oxygen-containing gas. It is particularly advantageous in this case if the closed-loop control attempts, in as it were in a predictive fashion, to extrapolate the content of nitrogen oxides in the exhaust gas of the internal combustion engine at a future time. This can be done, for example, by virtue of the fact that in addition to the nitrogen oxide concentration through the use of a memory module and a differentiator, the increase in the oxygen concentration is also observed. It is thus easily possible to extrapolate the nitrogen oxide concentration in the future and thus also carry out estimations of the required quantity of reducing agent. In accordance with this estimation it is then possible for nitrogen oxides to be generated and then ammonia to be generated.

In this context it is particularly preferred that flow directing devices, which permit the proportion of exhaust gas flow that flows into the first flow region to be defined, are provided upstream of the common wall in the direction of flow between the first and second flow regions.

Basically, the use of the dividing wall per se causes the exhaust gas flows to be divided between the first and second flow regions. In this situation, a first geometric exhaust gas partial flow flows into the first flow region, and a second geometric exhaust gas partial flow flows into the second flow region. Depending on the connection it may be necessary for the first exhaust gas partial flow which flows through the first flow region to be larger or smaller than the first geometric exhaust gas partial flow. For example, it is advantageous to direct only a very small mass flow through the first flow region and relatively large mass flows through the second flow region. If the first geometric exhaust gas partial flow is larger than the required exhaust gas partial flow in such a case due, for example, to the space required by the plasma generator or the reformer/reactor, it may be necessary to provide devices in the front part of the wall which is impacted by the flow. The devices reduce the exhaust gas partial flow flowing into the first flow region. This can include, for example, tapering into this region or else a moveable flap which makes the proportion of exhaust gas partial flow variable.

It is also preferred to provide flow directing devices in which substantially the entire mass flow is directed through the second flow region. In such a case, it is necessary to ensure that the process gas which is supplied to the plasma generator contains both oxygen and sufficient nitrogen. For example, air can be used in this case as the process gas.

Irrespective of the provision of flow directing devices, the first flow region can also have a substantially closed-off construction at the input end. This means in particular that substantially no exhaust gas can flow into the first flow region. In such a case it is preferred for the first flow region to be configured in such a way that the process gas for the plasma generator, for example air, can flow into the first flow region and the exhaust gas heats the process gas through contact with the common wall.

It is advantageous to preheat the process gas of the reformer/reactor and/or of the plasma generator. This can be done through electrical resistance heating or else through transfer of heat from the exhaust gas. Furthermore it may be advantageous to cool the gas which flows into the at least one storage element by feeding in air when the desorption temperature is exceeded in the case of chemisorption or physisorption.

The embodiment of the first and second flow regions described in this application can also advantageously be implemented independently of the rest of the construction of the device, that is to say in isolation, according to the invention.

A mixer is preferably provided at least at one of the following locations:
a) at the junction of the first secondary line with the main line;
b) upstream of the particle separator; or
c) at the junction of the second secondary line with the first secondary line.

The at least one mixer can be constructed in this case as an active mixer and/or as a passive mixer. A passive mixer includes, for example, a mixer structure as described above. Furthermore, the particle separator can also include a passive mixer, that is to say can bring about mixing, in particular cross-mixing, of the gas flows flowing through it. An active mixer is understood in particular to be a turbine or a turbocharger. Furthermore, the mixer can be constructed as a swirl mixer.

Mixing gas flows, in particular the ammonia-containing gas flow with the main exhaust gas flow, can preferably be carried out through the use of an active mixer, for example a turbocharger. Furthermore, the gas flows to be mixed can be mixed tangentially. Additionally, a mixer can be provided which has, for example, a honeycomb body with cells with a first repeating length and holes or cavities which have a dimension that is greater than the repeating length. Furthermore, the cell walls can have break-throughs with dimensions which are significantly smaller than the repeating length of the structures and directing structures which direct a gas flow into an adjacent cell.

Furthermore, it may be advantageous to also conduct the ammonia-containing gas flow through the particle separator. In particular, the ammonia-containing gas flow can have a positive effect on the regeneration of the particle filter. In such a case, the particle separator can also advantageously cause the ammonia-containing gas flow to be mixed with the main exhaust gas flow. In such a case, it is possible to select a construction of the device in which the first secondary line opens into the main exhaust line upstream of the particle separator and of the SCR catalytic converter.

A development of the device in which flow directing devices are provided that permit a proportion of exhaust gas or of gas flow which flows into the first secondary line to be adjusted, is also preferred. These flow directing devices can include throttles and/or valves.

The enrichment of nitrogen monoxide advantageously takes place in the cold starting phase only if the at least one storage element which is provided downstream of the plasma generator is in an operating state which permits sorption of nitrogen oxides. This is the case in particular in chemisorbing storage elements at temperatures of approximately 200° C. and above.

Basically it is possible for a plurality of storage elements to be provided in series, and in addition it is possible to provide a downstream reduction device at which a reduction of nitrogen oxides, preferably nitrogen monoxide, to form ammonia, is catalyzed. The use, for example, of two storage elements, one of which is based on physisorption and one on chemisorption, is possible according to the invention.

Ammonia is preferably not made available until the SCR catalytic converter has reached its operating temperature above the starting temperature (“light-off temperature”). This catalytic converter preferably has a coating in which ammonia can be stored. The stored ammonia can be used as a buffer for the reduction of nitrogen oxide peaks which occur in the exhaust gas.

The method can preferably be carried out in such a way that during operation a positive transfer of heat takes place upstream of or into a storage element which is based on chemisorption, in order to keep the latter above the limiting temperature starting from which the corresponding reaction occurs to an appreciable degree. The method can preferably be carried out in such a way that during operation a negative transfer of heat takes place upstream of or into a storage element which is based on physisorption, in order to keep the latter at its desorption temperature.

An air supply device such as a blower or compressor which supplies the plasma generator with air as at least part of its process gas, can preferably be provided.

Monitoring of the temperature and/or concentration of the gas flows preferably takes place with a computer-supported model in which data is calculated at other points on the system through the use of input data, for example through the use of at least one measuring sensor or else on the basis of an engine management system.

An embodiment of the device in which the SCR catalytic converter and the particle separator form one unit is preferred. It is particularly preferred in this case that the same surfaces serve both for particle separation and/or agglomeration and for catalyzing the SCR process.

Connecting the particle separator and SCR catalytic converter to form one unit advantageously permits a compact device according to the invention to be constructed. The use of a surface both for particle separation and for SCR catalyzation permits an even more compact construction of the unit.

It is also preferred that the SCR catalytic converter be constructed in such a way that a first quantity of reducing agent, preferably ammonia, can be stored in it, in particular through a corresponding configuration of the coating of the SCR catalytic converter.

An embodiment of the device according to the invention in which at least one turbine is provided in the main exhaust line and the first secondary line branches off from the main exhaust line upstream of the turbine, is also preferred. It is particularly preferred in this case that the first secondary line opens into the main line downstream of a turbine. The pressure gradient which arises as a result of the turbine can advantageously be used to meter the quantity of gas flowing into the first secondary line, for example through the use of a flutter valve. A turbine is understood in this case in particular to be a turbocharger. If two or more in particular serial turbochargers are provided in the system, it is advantageously possible for the junction to be positioned downstream of one turbocharger and upstream of a further turbocharger.

It is furthermore preferred for devices for regulating the quantity of gas which flows into the first and/or second secondary line to be provided. In particular, these devices include a flutter valve and/or a moveable valve. It is thus advantageously possible to adapt and adjust the operating conditions of the ammonia generator provided in the first secondary line.

It is also preferred for the reformer and/or reactor to be provided with a process gas which can be extracted at least partially from an exhaust gas recirculation line.

A device in which all of the components of the device, that is to say in particular the ammonia generator, the particle separator and the SCR catalytic converter, are provided in a common housing, is also preferred. This advantageously permits easy connection to the exhaust system and the device can therefore be used as a “black box”, in particular also for retrofitting exhaust systems.

With the objects of the invention in view, there is also provided a method for treating or preparing exhaust gas. The method comprises providing a main exhaust line, at least partially separating particles located in the exhaust gas in a particle separator in the main exhaust line, providing a first secondary line for generating ammonia, and at least partially reducing nitrogen oxides in the exhaust gas in an SCR catalytic converter with the ammonia received from the first secondary line as a reducing agent.

It is preferred in this case to generate the ammonia in the first secondary line from at least one educt which is gaseous at room temperature. Furthermore, the generation of ammonia from a nitrogen source which is gaseous at room temperature is preferred. In particular, air and/or exhaust gas can serve as the nitrogen source.

In accordance with another mode of the invention, the first secondary line and the main exhaust line are combined in such a way that the ammonia-containing gas stream which is generated in the first secondary line can flow through the particle separator.

In accordance with a further mode of the invention, at least one electrical field is generated in the particle separator for carrying out at least one of the following functions:
a) agglomeration of the particles;
b) separation of the particles; or
c) regeneration of the particle separator.

Agglomeration according to step 58.1) is understood in this case to mean the deposition of particles on particles so that particles with relatively large average diameters are produced. This can occur in particular due to the application of a direct voltage or a low-frequency alternating voltage. Separation in the sense of step 58.2) is understood in this case to mean the removal of the particles from the exhaust gas flow. Step 58.3) is understood in this case to mean the removal of particles through the use of an electrical field.

In accordance with an added mode of the invention, the particle separator has a regeneration facility or ability for regenerating the particle separator. It is particularly preferred in this case for the regeneration facility to be based on at least one of the following mechanisms:
a) making available nitrogen dioxide upstream of at least part of the particle separator;
b) increasing the temperature of the particle separator above a limiting temperature;
c) making available an oxidizing agent upstream of at least part of the particle separator; or
d) regeneration through the use of an electrical discharge.

Regeneration of a particle separator is understood, in particular, to mean the removal of the separated particles from the particle separator. A regeneration facility is understood to mean the suitability of the particle separator for regenerating the embedded and/or deposited particles, that is to say the removal of the particles from outside and/or inside the particle separator. This regeneration facility can, in particular, have a thermal and/or chemical configuration.

If the particle separator has a thermal regeneration facility according to step 60.2), devices can be provided which can bring about heating of the particle separator above a temperature at which oxidation of the carbon of the particles occurs, preferably also with a residual oxygen content in the exhaust gas. The particle separator can include catalytically active materials which catalyze such oxidation. Thermal regeneration can be achieved by increasing the exhaust temperature and/or through the use of additional heating devices.

If the particle separator has a chemical regeneration facility according to steps 60.1) and/or 60.3), it is possible to break down the particles through a chemical reaction. This can be achieved, for example, through a reaction of the carbon with nitrogen dioxide to form nitrogen monoxide and carbon dioxide. A further regeneration facility takes the form of a CRT method in which devices are provided that as continuously as possible ensure sufficiently large nitrogen dioxide concentration in the exhaust gas in the particle separator in order to continuously convert the carbon particles in this way. A regeneration facility which is based on an electrical discharge according to step 60.4) is based, for example, on a surface creeping discharge.

In accordance with an additional mode of the invention, ammonia is generated by plasma-supported generation of nitrogen monoxide and subsequent reduction to form ammonia.

With respect to the generation of nitrogen monoxide through the use of a plasma, reference is made to German Published, Non-Prosecuted Patent Application DE 102 58 185 A1, corresponding to U.S. Patent Application Publication No. US 2004/0168905 A1, the disclosure of which is incorporated into the disclosure of this application, to this extent.

It is preferred in this case to operate a plasma generator with a first process gas which includes at least nitrogen and oxygen. In particular, air and/or exhaust gas can be used as the process gas in this case.

Furthermore, a method in which the ammonia generator preferably includes at least one storage element in which nitrogen oxides can be reversibly stored, is preferred.

The reversible storage of nitrogen oxides makes it possible to provide two gas lines which can be connected to the plasma generator so that nitrogen oxides can be respectively stored in one gas line and nitrogen oxides can be released in another, and the nitrogen oxides can then be reduced to form ammonia. Storage elements including honeycomb bodies with a storage reducing coating in which nitrogen oxides are chemisorbed as nitrites and/or nitrates, are preferred.

Furthermore, a method in which at least two storage elements are provided in which nitrogen oxides are embedded in at least one storage element, while stored nitrogen oxides are released from at least one storage element, is preferred. Furthermore, in this context a method is preferred in which nitrogen oxides are alternately embedded and released in each storage element.

An embodiment of the method in which the storage of nitrogen oxides is based on physisorption and/or chemisorption is preferred.

Furthermore, a method is preferred in which the embedding and the release of the nitrogen oxides take place as a function of at least one physical and/or chemical method variable. In this context, the at least one method variable particularly preferably includes at least one of the following variables:
a) temperature of the exhaust gas;
b) temperature of the storage element; or
c) concentration of a component of the gas flowing through the storage element.

In this context, a method in which the method variable according to item 69.3) includes the concentration of at least one of the following substances is particularly preferred:
a) hydrogen; or
b) hydrocarbons.

In this context, the substance 70.1) is preferably made available through the use of a reformer and/or reactor, in particular is generated through the use of partial oxidation of hydrocarbons. In this context, the reformer and/or reactor are preferably provided in a second secondary line.

It is particularly advantageous if the second secondary line opens into the first secondary line upstream of the storage element. The second secondary line can preferably be heated, in particular upstream of the reformer and/or reactor, especially through the use of the waste heat of the exhaust gas. Direct heating of the reformer and/or reactor is also possible according to the invention. Additional heating can occur, for example through the use of an electric resistance heater as well as or in addition to heating through the use of the waste heat of the exhaust gas. The second secondary line can be charged with hydrocarbons and, if appropriate, air as a process gas.

The nitrogen oxides are preferably stored at temperatures substantially below a first limiting temperature on the basis of physisorption.

A method in which the nitrogen oxides are stored at temperatures substantially above a second limiting temperature on the basis of chemisorption is also preferred.

In this context,
a) a storage element is preferably provided on or in which the nitrogen oxides are reversibly stored substantially through the use of physisorption and chemisorption; or
b) at least two storage elements are preferably provided, with the nitrogen oxides being reversibly stored on or in at least one of these storage elements substantially through the use of physisorption, and the nitrogen oxides being reversibly stored on or in at least one other storage element substantially through the use of chemisorption;

wherein the at least one storage element is configured in such a way that the first limiting temperature is significantly higher than the second limiting temperature.

In step 76.1), a honeycomb body can have a corresponding coating which includes, for example, a zeolite or a similar molecular sieve for physisorption, and it is correspondingly configured in such a way that chemisorption takes place alternatively or cumulatively.

Furthermore, a method is preferred in which:

at the at least one storage element there is a storage temperature,

at least at one reformer there is a reformer temperature, and

in the exhaust gas there is an exhaust temperature,

in which case there can be a positive transfer of heat from the exhaust gas to at least one of the following components or a negative transfer of heat from at least one of the following components:
a) at least one storage element; or
b) at least one reformer or reactor;

wherein the transfer of heat meets at least one of the following conditions:

77.1.a) the transfer of heat to or from a storage element at which physisorption predominantly takes place is closed-loop and/or open-loop controlled in such a way that the storage temperature remains substantially below the first limiting temperature;

77.1.b) the transfer of heat to or from a storage element at which predominantly chemisorption occurs is closed-loop and/or open-loop controlled in such a way that the storage temperature occurs substantially above the second limiting temperature and below a third limiting temperature above which desorption of the nitrogen oxides takes place; or

77.2.a) the transfer of heat to or from a reactor is closed-loop and/or open-loop controlled in such a way that the reactor temperature is in a range in which the reactor generators hydrogen-containing gases.

In accordance with yet another mode of the invention, nitrogen monoxide is enriched by a plasma generator if a storage temperature of at least one storage element that is based at least partially on chemisorption is above the second limiting temperature.

A method in which the mass flow of the first process gas for the plasma generator corresponds substantially to a first predefinable value is also preferred if the storage temperature of a storage element which is partially based on chemisorption is below the second limiting temperature and above a second predefinable value that is higher than the first predefinable value when the storage temperature is above the second limiting temperature.

A method in which the above-mentioned temperatures are determined at least partially through the use of a computer-supported model is basically preferred.

In particular in this context, the sensing of at least one temperature through the use of a measuring sensor is also particularly preferred.

In accordance with yet a further mode of the invention, the ammonia production is closed-loop and/or open-loop controlled as a function of the NOₓ concentration and/or ammonia concentration in the exhaust gas. In this context, it is particularly preferred that a NOₓ and/or an ammonia content of the exhaust gas are sensed through the use of a measuring sensor.

In this context, in particular it is also possible for the NOₓ content and/or ammonia content of the exhaust gas to be determined indirectly by sensing a different concentration through the use of a measuring sensor and then obtaining the NOₓ and/or ammonia concentration therefrom. Furthermore, a plurality of measuring sensors can also be provided in the exhaust system.

In accordance with a concomitant mode of the invention, the NOₓ concentration is determined from operating data of the internal combustion engine.

In particular, the NOₓ concentration in the exhaust gas can be configured from an engine characteristic diagram. It is advantageously possible to adapt the NOₓ concentration value through the use of measured values.

A method sequence in which at least one turbine is provided in the main exhaust line and the first secondary line branches off from the main exhaust line upstream of the turbine, is particularly preferred. Furthermore, it is preferred that the first secondary line leads into the main exhaust line downstream of a turbine.

In this case, the pressure gradient which occurs as a result of the turbine can advantageously be used to regulate the flow of process gas in the first secondary line. In particular, devices for regulating the flow of process gas, for example a flutter valve or the like, can be provided.

The quantity of gas which flows into the first and/or second secondary line is advantageously closed-loop and/or open-loop controlled, preferably through the use of a flutter valve and/or a moveable flap.

One development of the method in which the reformer and/or reactor is charged with a process gas that can be extracted at least partially from an exhaust gas recirculation line, is preferred.

In particular, the exhaust gas recirculation line can be connected through corresponding flow directing devices to a second secondary line in which the reformer and/or reactor is provided. These flow directing devices can be advantageously used to perform open-loop and/or closed-loop control of the gas mass flow through the second secondary line.

It is also particularly preferred for the reformer and/or reactor and/or the plasma generator to be charged with a process gas which is pre-heated.

The pre-heating can, in particular, be carried out through the use of an electric heater and/or by using the waste heat of the exhaust gas.

The details which are disclosed herein for the device according to the invention can be transferred in the same way to the method according to the invention. In particular, the description of the components which are used, such as the particle separator, the ammonia generator, the SCR catalytic converter, the honeycomb bodies etc., can be transferred directly to the method according to the invention.

Other features which are considered as characteristic for the invention are set forth in the appended claims.

Although the invention is illustrated and described herein as embodied in a method and a device for treating exhaust gases of internal combustion engines, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, longitudinal-sectional view of a first exemplary embodiment of an exhaust gas treatment unit as part of a device according to the invention;

FIG. 2 is a fragmentary, longitudinal-sectional view of a second exemplary embodiment of an exhaust gas treatment unit as part of a device according to the invention;

FIG. 3 is a fragmentary, longitudinal-sectional view of a first exemplary embodiment of an exhaust system;

FIG. 4 is a fragmentary, longitudinal-sectional view of a second exemplary embodiment of an exhaust system;

FIG. 5 is a cross-sectional view of an exhaust gas treatment unit as part of a device according to the invention;

FIG. 6 is a block diagram of a first exemplary embodiment of a device according to the invention;

FIG. 7 is a block diagram of a second exemplary embodiment of a device according to the invention;

FIG. 8 is a fragmentary, elevational view of a first example of a particle separator;

FIG. 9 is a fragmentary, elevational view of a second example of a particle separator;

FIG. 10 is a diagrammatic and schematic view of a third exemplary embodiment of a device according to the invention;

FIG. 11 is a diagrammatic and schematic view of an example of an ammonia generator; and

FIG. 12 is a fragmentary, elevational view of an example of a particle separator.

### DETAILED DESCRIPTION OF THE INVENTION

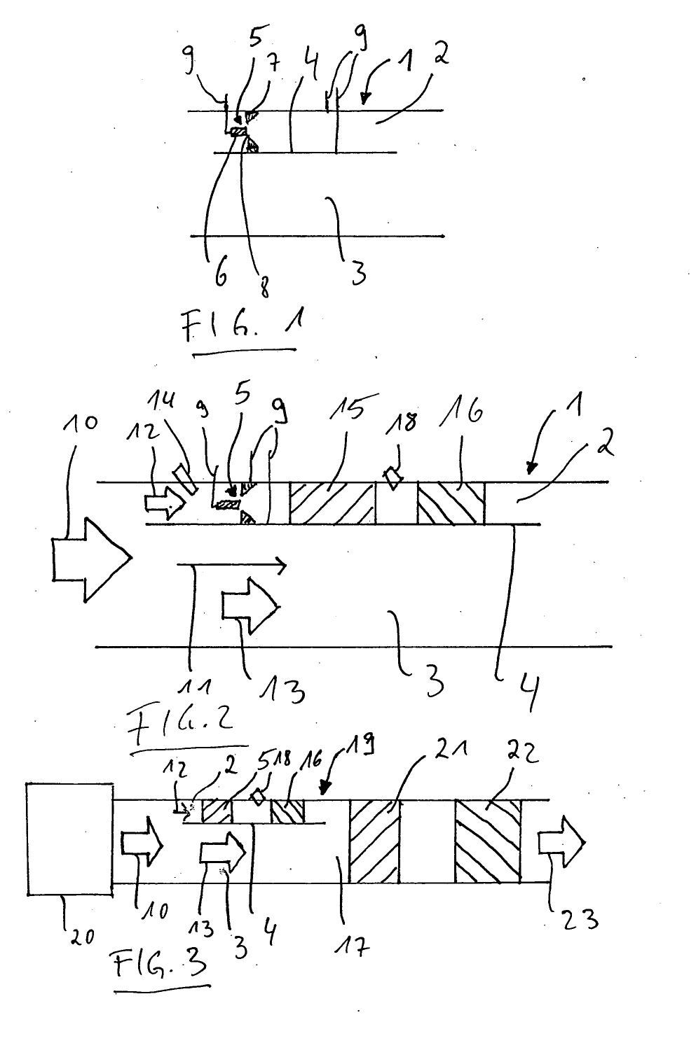

Referring now to the figures of the drawings in detail and first, particularly, to FIG. 1 thereof, there is seen a diagrammatic, longitudinal-sectional view of a first exemplary embodiment of an exhaust gas treatment unit 1. The exhaust gas treatment unit 1 may be part of a device according to the invention which, however, can also be advantageously implemented without the other components of the device according to the invention. The exhaust gas treatment unit 1 includes a first flow region 3 and a second flow region 2, which can have substantially parallel flows to one another and which are separated from one another by a dividing wall 4. A plasma generator 5 is provided in the second flow region 2. The second flow region 2 is part of a first secondary line 105, and the first flow region 3 is part of a main exhaust line 104, which are shown in other figures and discussed below. If an alternative or cumulative second flow region 2 is provided with a reactor 133 and/or a reformer 111, the second flow region 2 may be part of a second secondary line 110, which are shown in other figures and discussed below.

In the present example, the plasma generator 5, which may in particular be provided according to one of the types shown in German Published, Non-Prosecuted Patent Application DE 102 58 185 A1, corresponding to U.S. Patent Application Publication No. US 2004/0168905 A1, is provided in the second flow region 2. The plasma generator includes a first electrode 6 and a second electrode 7. The second electrode 7 is provided in a funnel shape around a plasma cell 8. In the plasma cell 8, a high voltage, which can be embodied as a direct voltage or an alternating voltage, is applied to the electrodes 6, 7, and a plasma is thus generated. Through the use of this plasma, which brings about gas temperatures of more than 2500 Kelvin for a short time, increased conversion of nitrogen and oxygen to nitrogen monoxide takes place. An electrical power supply is provided through ports 9.

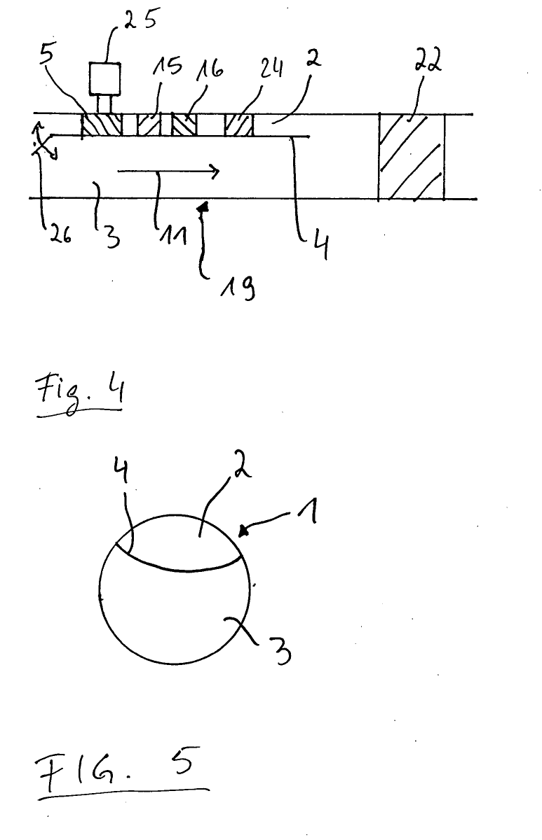

FIG. 2 is a diagrammatic view of a second exemplary embodiment of an exhaust gas treatment unit 1 with a first flow region 3 and a second flow region 2, which in particular can be part of a device according to the invention for treating exhaust gas. When the exhaust gas treatment unit 1 is used in the exhaust system of an internal combustion engine 100 shown in other figures and discussed below, an exhaust gas flow 10 flows through the exhaust gas treatment unit 1 in a flow direction 11. The exhaust gas flow 10 is divided into a first exhaust gas partial flow 12 and a second exhaust gas partial flow 13 through the use of the dividing wall 4 which divides the flow regions 2, 3. In the first exhaust gas partial flow 12, which flows through the second flow region 2, nitrogen monoxide is enriched through the use of the plasma generator 5. An oxygen-containing and, if appropriate, nitrogen-containing gas can be supplied upstream of the enrichment in the plasma generator 5, through the use of a gas supply device 14. This gas may, in particular, be air. The oxygen-containing gas is preheated through contact of the oxygen-containing gas with the common wall 4, as a result of the exhaust gas flowing on the other side of the common wall 4. Both the exhaust gas and air contain sufficient nitrogen (N₂) which is made available for oxidizing to form nitrogen oxides (NOₓ), preferably to form nitrogen monoxide (NO). After enrichment of the first exhaust gas partial flow 12 with nitrogen monoxide, reduction of oxygen which is still contained in the first exhaust gas partial flow 12 occurs in a first honeycomb structure 15 which has a first reducing catalyst coating, in the second exemplary embodiment of the exhaust gas treatment unit 1. An exhaust gas can flow through the first honeycomb structure 15 in the flow direction 11. The honeycomb structure 15 has, in particular, corresponding cavities or cells which run through the first honeycomb structure 15. The first honeycomb structure 15, just like all the other honeycomb structures disclosed in this case, can in particular be constructed as a ceramic monolith or from at least partially structured metallic layers. A second honeycomb structure 16 is provided downstream of the first honeycomb structure 15 in the flow direction 11. The second honeycomb structure 16 has a second reducing catalyst coating for reducing nitrogen monoxide to form ammonia. As a result, an ammonia-containing first exhaust gas flow 12 is present downstream of the second honeycomb structure 16 in the flow direction 11.

As a result of the location of the downstream end of the dividing wall 4 in the flow direction 11, a common third flow region 17, in which the first exhaust gas partial flow 12 and the second exhaust gas partial flow 13 are combined again, is provided downstream of this end of the wall. A reducing agent supply device 18 is provided upstream of the second honeycomb structure 16, in the flow direction 11. A reducing agent which is required to reduce nitrogen monoxide to form ammonia in the second honeycomb structure 16 can be supplied through the use of this reducing agent supply device 18. Hydrocarbons, for example the fuel of the internal combustion engine can, in particular, be supplied as reducing agents in this case.

FIG. 3 is a diagrammatic view of an exhaust system 19. The exhaust gas flow 10 of an internal combustion engine 20 flows through the exhaust system 19. The dividing wall 4 divides a first flow region 3 from a second flow region 2. In this case, the exhaust gas flow 10 is divided into a first exhaust gas partial flow 12 and a second exhaust gas partial flow 13 which flow through the second flow region 2 and the first flow region 3, respectively. The first exhaust gas partial flow 12 passes through a plasma generator 5 in which nitrogen monoxide in the first exhaust gas partial flow 12 is enriched. After the first exhaust gas partial flow 12 has left the plasma generator 5, it flows through a second honeycomb structure 16 in which the nitrogen monoxide is reduced to form ammonia. For this purpose, a hydrocarbon-containing or hydrogen-containing reducing agent, in particular fuel of the internal combustion engine, is added through a reducing agent supply device 18. The first exhaust gas partial flow 12, which now contains ammonia after it has left the first flow region 3, mixes with the second exhaust gas partial flow 13 having passed through the first flow region 3, in the common third flow region 17. The mixing of the two exhaust gas partial flows 12, 13 is promoted by a mixer structure 21 in which the two exhaust gas partial flows 12, 13 are mixed. The mixer structure 21 can be constructed from corresponding metal foils in such a way that on one hand a crossflow can take place substantially perpendicularly to the flow direction 11, and that in addition directing structures are provided which forcibly bring about or promote crossflow on the other hand.

After the exhaust gas flow has left the mixer structure 21, it then flows into a third honeycomb structure 22. This third honeycomb structure 22 is provided with a third reducing catalyst coating which catalyzes a selective catalytic reduction of nitrogen oxides with the reducing agent ammonia. The third honeycomb structure 22 thus leaves a cleaned exhaust gas flow 23 having a nitrogen oxide content which is at least substantially reduced as compared to the nitrogen oxide content of the exhaust gas flow 10.

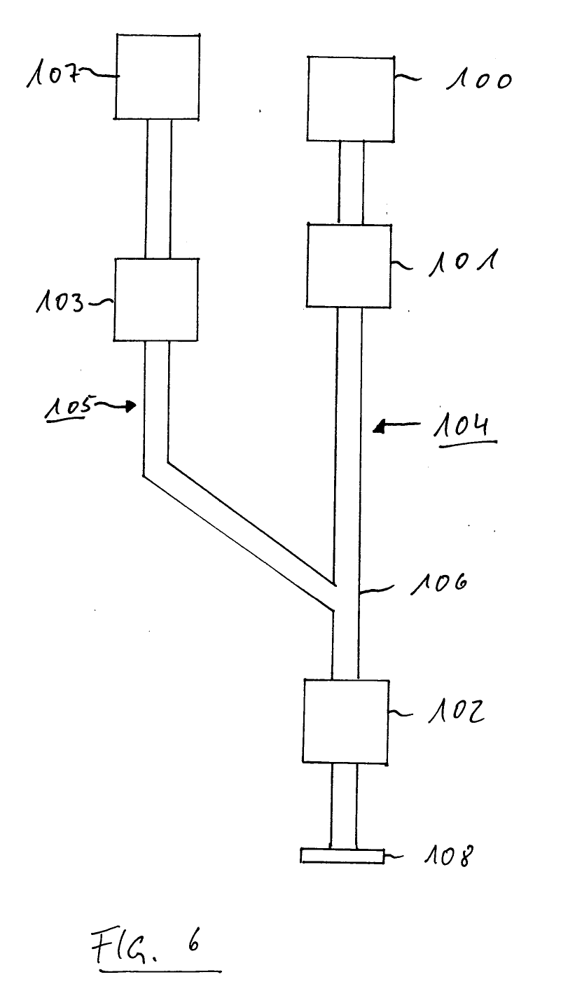

FIG. 4 is a diagrammatic view of a second exemplary embodiment of an exhaust system in a longitudinal section. In the exhaust system 19, at first a plasma generator 5 is provided in a second flow region 2. A first honeycomb structure 15 for reducing residual oxygen, which may still be present in the partial exhaust gas flow, is provided downstream of the plasma generator 5, in the flow direction 11. Furthermore, a second honeycomb structure 16, in which the nitrogen monoxide that is generated in the plasma generator 5 is reduced to form ammonia, is provided downstream. Furthermore, a device 24 for temporarily storing a reducing agent is provided downstream. This can, in particular, be ammonia which is formed in the second honeycomb structure 16. The device 24 for temporarily storing a reducing agent permits a portion of the reducing agent to be stored at times of excess reducing agent and to be released again later when necessary. This may take place, for example, through the use of a process which is based on chemisorption or physisorption and which can be reversed again by supplying heat when necessary.

The plasma generator 5 is connected to a control device 25, through the use of which the plasma generator is supplied with current. Furthermore, the exhaust system 19 has a flow directing device 26 which is provided upstream of the dividing wall 4 in the flow direction 11, between the first flow region 2 and the second flow region 3. This flow directing device 26, like all of the other flow directing devices disclosed herein can, for example, be embodied as a directing baffle or as a pivotable flap which also permits the division of the exhaust gas partial flows between the first flow region 2 and the second flow region 3 to be varied during operation. The mobility of the flow directing device 26 has been indicated by an arrow.

FIG. 5 is a diagrammatic view of a cross section through an exhaust gas treatment unit 1 in an area in which the first flow region 3 and the second flow region 2 have already been provided. These flow regions 2, 3 are divided by the dividing wall 4. In particular, a relatively cold gas which flows through the second flow region 2 can thus be heated by a relatively warm gas which flows through the first flow region 3. It is preferred in this case to heat a process gas for the plasma generator 5 in the second flow region 2 through the use of the exhaust gas from the internal combustion engine 20 which flows through the first flow region 3. An exhaust gas treatment unit 1 according to the invention can, in particular, also include what is referred to as a “double-D pipe” which is composed, for example, of two pipes that are shaped as Ds and which are secured, if appropriate, in a common tubular outer pipe.

The exhaust gas flow or gas mass flow which flows through the second flow region 2 is preferably small as compared to the exhaust gas mass flow which flows through the first flow region 3.

The exhaust gas treatment unit 1 advantageously permits the compact construction of a plasma generator 5 which operates in just one partial flow of the gas that flows through the exhaust gas treatment unit. An exhaust gas treatment unit 1 with a plasma generator 5 is particularly advantageously used in an exhaust system 19 within the scope of a system or a method for reducing the nitrogen oxide emissions of an internal combustion engine 20. Due to the compact construction of the plasma generator 5, it is suitable in particular for use in exhaust systems 19 of mobile systems such as, for example, motor vehicles, in particular passenger cars and trucks.

The exhaust gas treatment unit which is described with regard to FIGS. 1 to 5 and the corresponding other parts of the invention can also be implemented in isolation without the other parts of the device for post-treatment of exhaust gases.

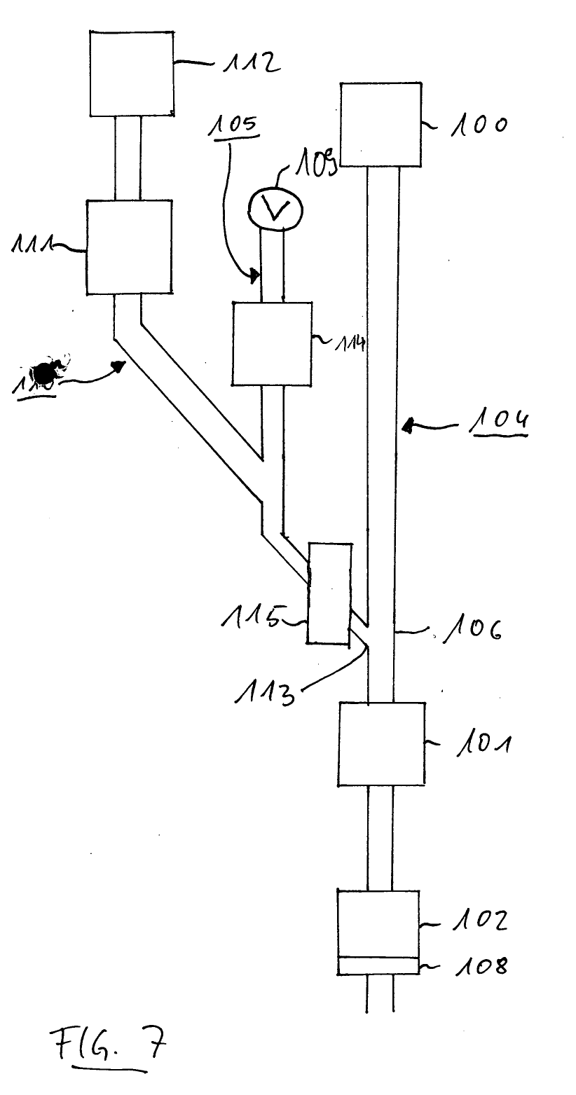

FIG. 6 is a block diagram of a first exemplary embodiment of a device according to the invention for preparing or treating exhaust gases of an internal combustion engine 100, which includes a particle separator 101, an SCR catalytic converter 102 for selective catalytic reduction of nitrogen oxides (NOₓ) and an ammonia generator 103, in which case the ammonia which is generated on-board in the ammonia generator is used as a selective reducing agent for selective catalytic reduction of nitrogen oxides in the SCR catalytic converter 102. According to the invention, the particle separator 101 is provided in the main exhaust line 104, and the ammonia generator 103 is provided in the first secondary line 105. The first secondary line 105 leads into the main exhaust line 104 at a junction 106. In the first exemplary embodiment, the junction 106 is provided upstream of the SCR catalytic converter 102.

A device 107 for making available at least one process gas for the ammonia generator 103 is provided upstream of the ammonia generator 103. This device 107 can also be included in the ammonia generator 103. The device 107 includes, in particular, at least one of the following devices:
a) a device for making available a nitrogen-containing process gas flow;
b) a device for making available a hydrogen-containing reducing agent flow; and
c) a device for making available an oxygen-containing process gas flow.

It is possible to provide a device for supplying exhaust gas, air and/or recycled exhaust gas as the devices a) and c). The device b) can include a reformer which generates a hydrogen-containing process gas through the use of partial oxidation from a hydrocarbon-containing educt.

A first oxidizing catalytic converter 108 can be provided downstream of the SCR catalytic converter 102. Ammonia or hydrocarbons which possibly break through the SCR catalytic converter 102 are oxidized in the oxidizing catalytic converter 108 and therefore not discharged into the surroundings.

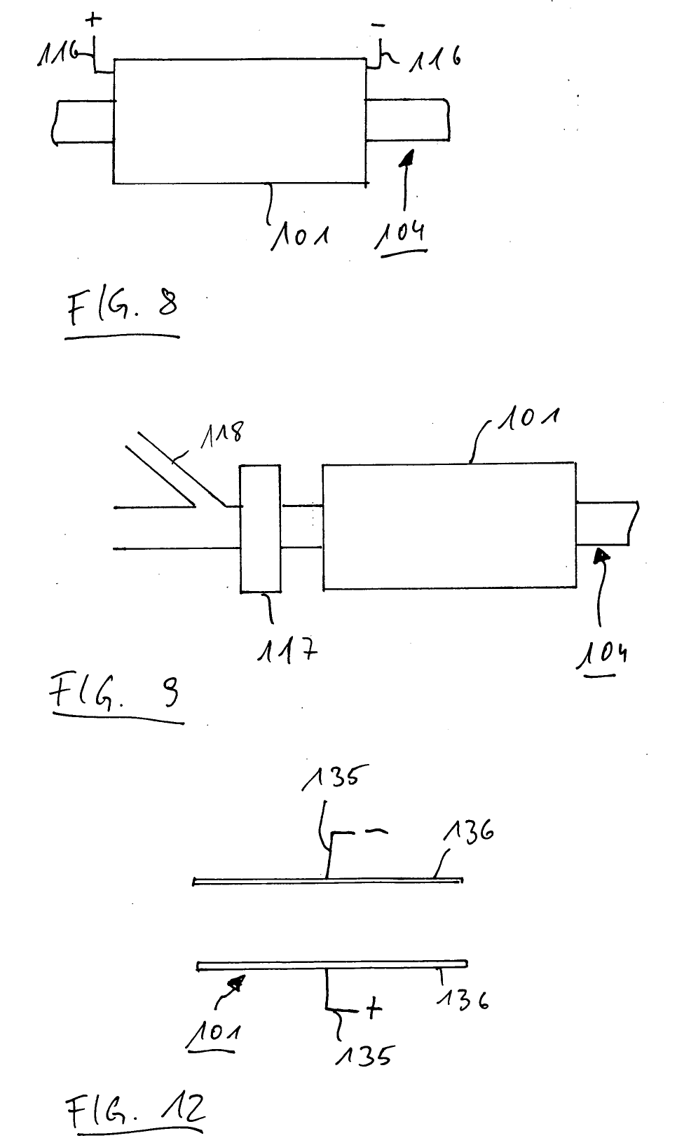

FIG. 7 is a diagrammatic view of a second exemplary embodiment of a device according to the invention for preparing or treating the exhaust gas of an internal combustion engine 100. In a main exhaust line 104, a particle separator 101, an SCR catalytic converter 102 and a first oxidizing catalytic converter 108 downstream of and connected to the SCR catalytic converter 102, are provided. The SCR catalytic converter 102 and the first oxidizing catalytic converter 108 can, in particular, be provided on a single honeycomb body.

An ammonia generator 103, including a plasma generator 114, is provided in the first secondary line 105. The plasma generator 114 is supplied with air as the process gas through a compressor 109. Furthermore, a second secondary line 110 which is provided in the second exemplary embodiment includes a reformer 111. The latter is connected to a fuel tank 112 from which the reformer 111 is supplied with hydrocarbons. Additionally, the reformer 111 is supplied with an oxygen-containing gas, for example air or exhaust gas which is extracted from the exhaust gas recirculation line. Partial oxidization of the hydrocarbons takes place in the reformer 111 so that a hydrogen-containing synthetic flow and/or cracking gas flow is produced and this can be fed into the first secondary line 105 through a second junction 113.

The plasma generator 114 generates a nitrogen oxide-containing, preferably nitrogen monoxide-containing, gas flow which is stored temporarily in a storage/reducing element 115. Chemisorption, during which the nitrogen oxides are stored in the form of nitrites and/or nitrates, is preferred in this case. The nitrites and nitrates can react in this case through the use of hydrogen to form ammonia. The storage/reducing element 115 then leaves an ammonia-containing gas flow which flows firstly through the particle separator 101 and then through the SCR catalytic converter 102. In the SCR catalytic converter 102, the ammonia acts as a reducing agent for the selective reduction of nitrogen oxides, and in the particle separator 101 it can serve as an inhibitor for the regeneration of a particle filter.

FIG. 8 is a diagrammatic view of a portion of a device according to the invention. The particle separator 101 is provided in the main exhaust line 104. The particle separator 101 includes a device 116 for generating a surface creeping discharge as a regeneration facility for the particle separator 101.

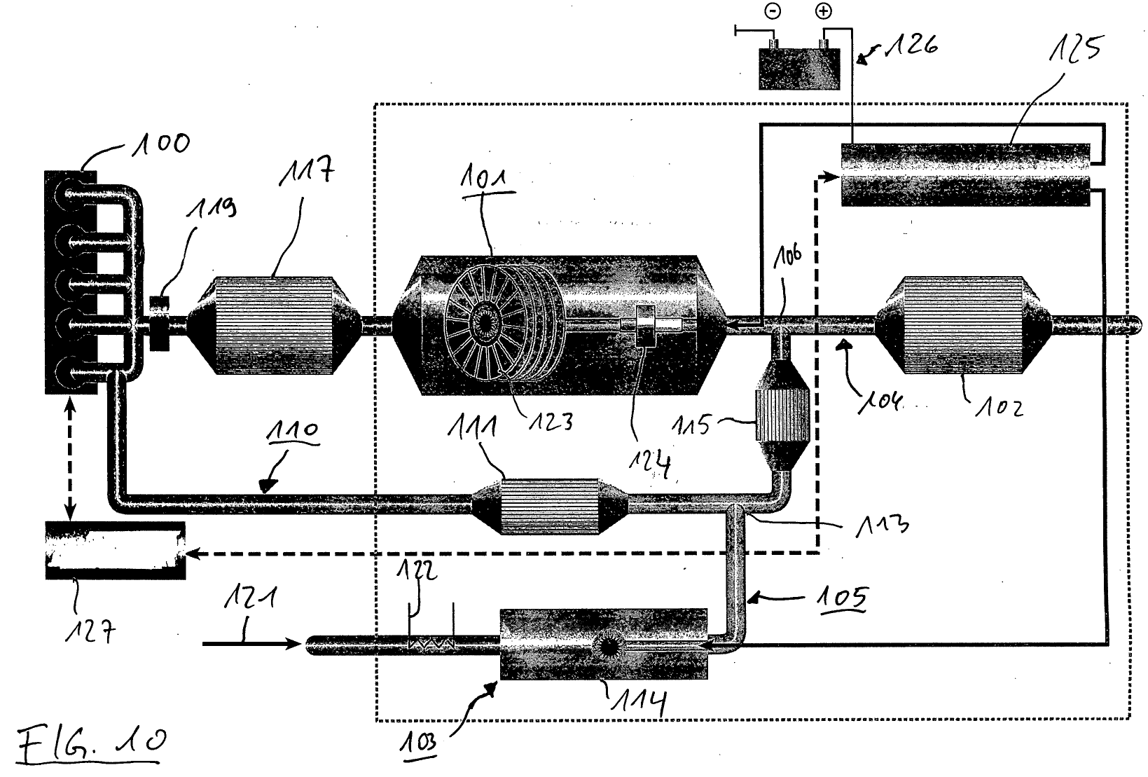

FIG. 9 is a diagrammatic view of a portion of a device according to the invention. A particle separator 101 is provided in the main exhaust line 104. A second oxidizing catalytic converter 117 is provided upstream, that is to say in the direction of the internal combustion engine 100. The oxidizing catalytic converter 117 can serve as a device both for thermal regeneration and for chemical regeneration of the particle separator 101. In the case of chemical regeneration facilities 10.1) and/or 10.3), the second oxidizing catalytic converter 117 can serve to oxidize nitrogen monoxide to form nitrogen dioxide, which can serve as a regeneration device for the particle separator, in particular within the scope of a CRT method. In the case of a thermal regeneration facility 10.2) of the particle separator 101, hydrocarbons can be applied to the second oxidizing catalytic converter 117 through a feed line 118. The hydrocarbons are converted there and cause the gas flow which flows through the particle separator 101 to be heated due to an exothermal oxidation of the hydrocarbons. The second oxidizing catalytic converter 117 can, in particular, also be part of the particle separator 101. The particle separator 101 can, in particular, also be equipped with an alternative or additional resistance heater or, for example, include a heatable plate in its gas-inlet-side area which faces the internal combustion engine 100.

FIG. 10 is a diagrammatic view of a third exemplary embodiment of a device according to the invention for treating the exhaust gas of an internal combustion engine 100. The exhaust system includes a main exhaust line 104 and a second secondary line 110 which branches off from the main exhaust line 104 upstream of a turbocharger 119. A reformer 111 is provided in the second secondary line 110. The second secondary line 110 branches off from the main line 104 in a junction 106. The junction 106 is provided upstream of the turbocharger 119, while a second junction 113 is provided downstream of the turbocharger 119.

Furthermore, a first secondary line 105 is provided in which an ammonia generator 103 including a plasma generator 114 is provided. Air and/or exhaust gas is used in this case as a process gas 121 for the plasma generator 114, or the process gas 121 is able to include exhaust gas and/or air. The process gas 121 can be heated, in particular by waste heat of the exhaust gas of the internal combustion engine and/or by an electric resistance heater 122.

During operation, the plasma generator 114 converts nitrogen and oxygen from the process gas 121 into nitrogen oxides, preferably into nitrogen monoxide. The plasma generator 121 is operated in such a way that the largest possible yield of nitrogen monoxide is achieved. The nitrogen oxide-containing gas flow is then directed through the storage/reducing element 115 in which the nitrogen oxides, preferably nitrogen monoxide, are chemisorbed and stored as nitrites and/or nitrates.

If the hydrogen-containing gas generated in the reformer 111 then flows through the storage/reducing element 115, the nitrites and/or nitrates are reduced to form ammonia. The ammonia-containing gas flow which is produced as a result is then directed through the SCR catalytic converter 102 and used there as a selective reducing agent for nitrogen oxides. The SCR catalytic converter 102 preferably includes a honeycomb body as described above.

In the main exhaust line 104, a second oxidizing catalytic converter 117 is provided, in which oxidation of nitrogen monoxide to form nitrogen dioxide is preferably catalyzed. This nitrogen dioxide (NO₂) then converts carbon (C) contained in the particles into carbon dioxide (CO₂) and is itself reduced to form a nitrogen monoxide (NO). As a result, the particle separator 101 can be regenerated.

The particle separator 101 can advantageously contain both at least one filter element 123 and a second plasma generator 124 which interacts with the at least one filter element 123 and which is embodied and operated in such a way that electrical surface creeping discharges trigger the regeneration of the filter elements. With respect to the embodiment and the operation of the plasma generator, reference is made to German Patent DE 100 57 862 C1, corresponding to U.S. Pat. No. 6,938,409, the content of the disclosure of which is incorporated by reference to this extent into the content of the disclosure of the invention of the instant application.

Furthermore, a control unit 125 is provided which can be connected to a voltage source 126. This control unit 125 controls the plasma generator 114 and the second plasma generator 124 jointly. In this context, data from an engine controller 127 can be taken into account. In particular, the NOₓ concentration in the exhaust gas can be determined by reference to the data from the engine controller 127, preferably by reference to an engine characteristic diagram.

The at least one filter element 123, the second oxidizing catalytic converter 117, the SCR catalytic converter 102, the reformer 111, the storage/reducing unit 115, the ammonia generator 103 and/or the particle separator 101 can include at least one honeycomb body. The components of the device can preferably be provided in a common housing 128.

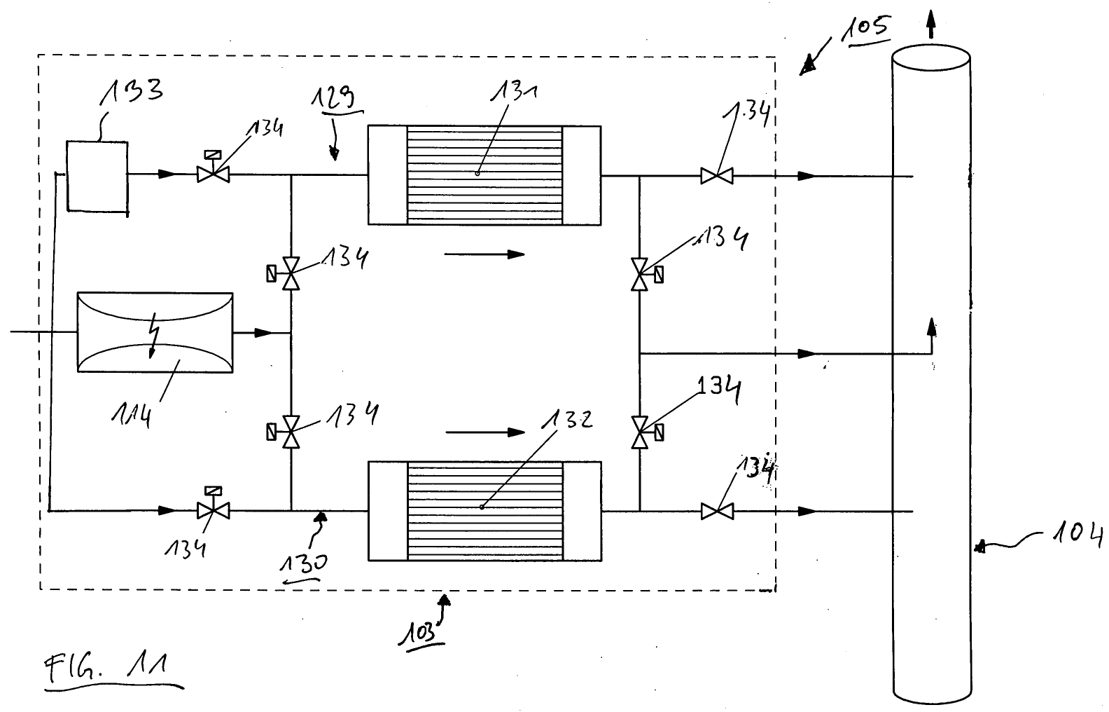

FIG. 11 is a diagrammatic view of an ammonia generator 103 which is provided in the first secondary line 105. The latter includes a plasma generator 114 in which nitrogen oxides, preferably nitrogen monoxide, is generated from a nitrogen-containing and oxygen-containing educt mixture. The gas flow which contains nitrogen monoxide that is generated in this way is fed into a first gas line 129 or a second gas line 130. The first gas line 129 includes a first storage/reducing element 131, and the second gas line 130 includes a second storage/reducing element 132. In the gas lines 129, 130 through which exhaust gas from the plasma generator 114 flows, the nitrogen oxides are chemisorbed at the corresponding storage/reducing element 131, 132. The storage takes place as a nitrite and/or nitrate. In the respective other gas line 130, 129, reduction and simultaneous conversion of the respective nitrite and/or nitrate groups to form ammonia occurs as a result of passing through a hydrogen-containing gas flow produced by the reactor 133. The ammonia-containing gas flow which is obtained as a result is fed into the main exhaust line 104 in order to be used as a selective reducing agent for reducing nitrogen oxides in the SCR catalytic converter 102 which is located downstream. The reactor 133 can, in particular, include a reformer and/or can generate hydrogen through partial oxidation of hydrocarbons.

The required quantity of hydrocarbon is reduced as a result of the intermittent operation of the plasma generator 114, during which in each case a storage/reducing element 131, 132 is filled and in parallel the respective other storage/reducing element 131, 132 is emptied, since it is possible in this way to keep the proportion of oxygen which is present during the emptying of the storage/reducing elements 131, 132 as small as possible. In this case, a reaction between the hydrogen and oxygen which consumes the hydrogen does not occur but rather the desired reduction of the nitrates/nitrites to form ammonia mainly occurs. The gas flows can be appropriately directed through the use of valves 134.

FIG. 12 shows an advantageous development in which the particle separator 101 includes at least two elements 136 which can be connected to a device 135 for generating a first electrical field. The particles can be agglomerated and/or separated through the use of the first electrical field.

The method according to the invention and the device according to the invention advantageously permit the proportion of particles and nitrogen oxides (NOₓ) contained in the exhaust gas of an internal combustion engine 100 to be reduced simultaneously, in which case the consumption of energy for this reduction is low and at the same time the entire device can be embodied as a compact unit.

1. A device for treating exhaust gases, the device comprising:
a main exhaust line;
a particle separator disposed in said main exhaust line;
a first secondary line;
an ammonia generator disposed in said first secondary line for generating ammonia as a selective reducing agent for reducing nitrogen oxides; and
an SCR catalytic converter for selectively reducing nitrogen oxides;
said first secondary line opening into said main exhaust line at a junction causing an ammonia-containing gas stream generated in said ammonia generator to flow through said SCR catalytic converter.

2. The device according to claim 1, wherein said first secondary line opens into said main exhaust line at said junction causing said ammonia-containing gas stream generated in said ammonia generator to also flow through said particle separator.

3. The device according to claim 1, wherein said particle separator has a regeneration facility for regenerating said particle separator.

4. The device according to claim 3, wherein said regeneration facility of said particle separator is provided by at least one of the following measures:
making available nitrogen dioxide upstream of at least part of said particle separator;
increasing temperature of at least part of said particle separator above a limiting temperature;
making available an oxidizing agent upstream of at least part of said particle separator; or
regeneration by an electrical discharge.

5. The device according to claim 4, which further comprises a device for regeneration by a surface creeping discharge.

6. The device according to claim 1, wherein said particle separator includes a device for generating an electrical field in said particle separator to carry out at least one of the following functions:
agglomeration of particles; or
separation of particles.

7. The device according to claim 1, wherein said particle separator includes a device for generating an electrical field in said particle separator to generate a surface creeping discharge for regeneration.

8. The device according to claim 1, wherein said ammonia generator includes a plasma generator.

9. The device according to claim 1, wherein said ammonia generator includes at least one storage element for temporarily storing at least one of the following components:
ammonia; or
an ammonia precursor.

10. The device according to claim 9, wherein said components include nitrogen monoxide.

11. The device according to claim 1, wherein at least one of the following gases flows through said first secondary line:
exhaust gas;
a gas including at least oxygen and nitrogen; or
air.

12. The device according to claim 1, which further comprises an oxidizing catalytic converter disposed at least at a location selected from the group consisting of:
upstream of said particle separator;
downstream of said ammonia generator and upstream of said SCR catalytic converter; or
downstream of said SCR catalytic converter.

13. The device according to claim 1, which further comprises a first flow region and at least one second flow region having substantially mutually parallel flows, said first flow region being at least part of said main exhaust line, and said first flow region and said second flow region permitting heat to be transferred from said first flow region into said at least one second flow region.

14. The device according to claim 13, wherein said second flow region includes at least one component selected from the group consisting of:
at least one plasma generator,
at least one reformer; or
at least one reactor.

15. A method for treating exhaust gas, the method comprising the following steps:
providing a main exhaust line;
at least partially separating particles located in the exhaust gas in a particle separator in the main exhaust line;
providing a first secondary line for generating ammonia; and
at least partially reducing nitrogen oxides in the exhaust gas in an SCR catalytic converter with the ammonia received from the first secondary line as a reducing agent.

16. The method according to claim 15, which further comprises combining the first secondary line and the main exhaust line to cause an ammonia-containing gas stream generated in the first secondary line to flow through the particle separator.

17. The method according to claim 15, which further comprises generating at least one electrical field in the particle separator for carrying out at least one of the following functions:
agglomeration of the particles;
separation of the particles; or
regeneration of the particle separator.

18. The method according to claim 15, wherein the particle separator has a regeneration facility for regenerating the particle separator.

19. The method according to claim 18, which further comprises carrying out the regeneration facility based on at least one of the following mechanisms:
making available nitrogen dioxide upstream of at least part of the particle separator;
increasing temperature of at least part of the particle separator above a limiting temperature;
making available an oxidizing agent upstream of at least part of the particle separator; or
regeneration by an electrical discharge.

20. The method according to claim 19, wherein the regeneration by an electrical discharge includes a surface creeping discharge.

21. The method according to claim 15, which further comprises generating the ammonia by plasma-supported generation of nitrogen monoxide and subsequent reduction to form ammonia.

22. The method according to claim 21, which further comprises operating a plasma generator with a nitrogen-containing and oxygen-containing first process gas.

23. The method according to claim 15, which further comprises generating the ammonia in an ammonia generator.

24. The method according to claim 23, wherein the ammonia generator includes at least one storage element for reversibly storing nitrogen oxides.

25. The method according to claim 15, which further comprises at least one of closed-loop or open-loop controlling an ammonia production as a function of at least one of an NOₓ concentration or ammonia concentration in the exhaust gas.

26. The method according to claim 25, which further comprises sensing at least one of an NOₓ content or ammonia content of the exhaust gas with a measuring sensor.

27. The method according to claim 25, which further comprises determining the NOₓ concentration from operating data of an internal combustion engine.
